(19) United States
(12) Patent Application Publication
(10) Pub. No.: US 2016/0104557 A1
(43) Pub. Date: Apr. 14, 2016

(54) HIGHLY-FLEXIBLE ELECTRIC WIRE

(71) Applicant: YAZAKI CORPORATION, Tokyo (JP)

(72) Inventors: Yuki TOSAYA, Shizuoka (JP); Satoru YOSHINAGA, Shizuoka (JP)

(73) Assignee: YAZAKI CORPORATION, Tokyo (JP)

(21) Appl. No.: 14/976,519

(22) Filed: Dec. 21, 2015

Related U.S. Application Data
(63) Continuation of application No. PCT/JP2014/065975, filed on Jun. 17, 2014.

(30) Foreign Application Priority Data
Jun. 24, 2013 (JP) 2013-131806

(51) Int. Cl. H01B 7/18; C10M 107/38

(52) U.S. Cl. CPC H01B 7/1885; C10M 107/38

(57) ABSTRACT

A highly-flexible electric wire includes: a conductor; and an insulator layer covering the conductor and further includes a liquid lubricant interposed between the conductor and insulator layer. The lubricant contains at least one selected from the group consisting of polyethylene glycol, polypropylene glycol, and fluorine lubricants. Such a configuration enables the conductor and insulator layer to slide smoothly on each other, therefore increasing the flexibility.

### CROSS REFERENCE TO RELATED APPLICATION

This application is a Continuation of PCT Application No. PCT/JP2014/065975, filed on Jun. 17, 2014, and claims the priority of Japanese Patent Application No. 2013-131806 filed on Jun. 24, 2013, the content of all of which is incorporated herein by reference.

### BACKGROUND

1. Technical Field

The present invention relates to a highly-flexible electric wire. Specifically, the present invention relates to a highly-flexible electric wire having high durability in an environment where the electric wire is repeatedly bent.

2. Related Art

Electric wires connected to vehicle suspensions and similar devices as well as electric wires used for driving in robotic arms and the like are forcibly bent by external force because these electric wires are used in sections that frequently move. Accordingly, such electric wires are required to have high bending durability.

One type of cable conventionally disclosed includes a stranded conductor having: strands each composed of a bundle of plural wires; and small-diameter inclusions provided between the adjacent strands in order to increase the bending durability of the electric wire (see Patent Literature 1, for example). Moreover, a type of insulating wire is disclosed which is made flexible by the inclusion of a jacket around the conductor, which contains alumina, silica, silica aluminate, or zeolite (see Patent Literature 2, for example).

Patent Literature 1: Japanese Patent Unexamined Publication No. 2011-18545

Patent Literature 2: Japanese Patent Unexamined Publication No. 2010-177189

### SUMMARY

However, in the cable described in Patent Literature 1, inserting the small-diameter inclusions between the wires to prevent abrasion therebetween can increase the manufacturing cost. Moreover, since the small-diameter inclusions are inserted between the wires, the cable has a larger cross-sectional area, therefore making it difficult to construct a circuit in a small narrow space. Furthermore, since the jacket of the insulating wire in Patent Literature 2 is mainly composed of inorganic oxide, the bending durability is not high enough.

The present invention was made in the light of the above-described problems of the conventional techniques. An object of the present invention is to provide a highly-flexible electric wire having bending durability increased without increasing in cost and thickness.

A highly-flexible electric wire according to a first aspect of the present invention includes: a conductor; and an insulator layer covering the conductor, in which a liquid lubricant is interposed between the conductor and the insulator layer and contains at least one selected from the group consisting of polyethylene glycol, polypropylene glycol, and fluorine lubricants.

A highly-flexible electric wire according to a second aspect of the present invention relates to the highly-flexible electric wire of the first aspect, in which the conductor is a stranded conductor composed of a bundle of plural wires, and the lubricant is interposed between the conductor and the insulator layer and between the wires adjacent to each other.

A highly-flexible electric wire according to a third aspect of the present invention relates to the highly-flexible electric wire of the first or second aspect, in which the lubricant is in liquid state in a temperature range from −40 to 80° C. and has a boiling point of 150° C. or higher.

### BRIEF DESCRIPTION OF DRAWINGS

FIG. 1 is a cross-sectional view illustrating a highly-flexible electric wire according to an embodiment of the present invention.

FIG. 2 is a cross-sectional view illustrating a highly-flexible electric wire according to another embodiment of the present invention.

FIG. 3 is a schematic view for explaining an apparatus performing a bending durability test.

FIG. 4 is a graph illustrating the results of the bending durability test.

### DETAILED DESCRIPTION

Hereinafter, a description is given of a highly-flexible electric wire according to an embodiment of the present invention in detail using the drawings. The dimensional proportions of the drawings are exaggerated for convenience of explanation and are different from actual ones in some cases.

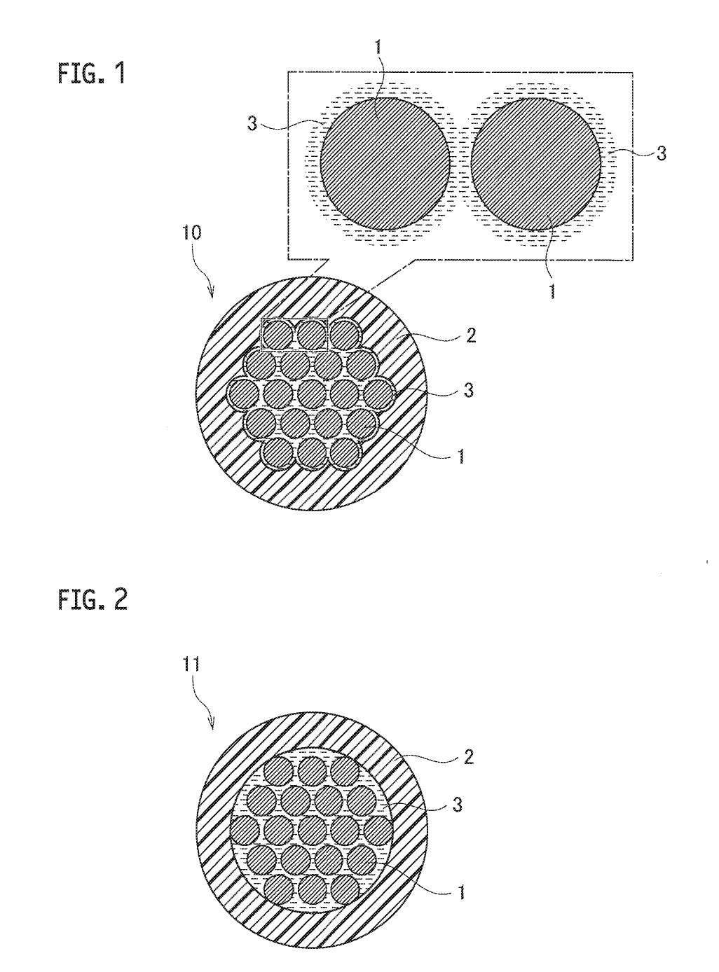

A highly-flexible electric wire 10 according to the embodiment includes a conductor 1 and an insulator layer 2 covering the conductor 1 as illustrated in FIG. 1.

The conductor 1 may be a solid conductor composed of a single wire or a stranded conductor composed of a bundle of plural wires. The stranded conductor can be: a concentric stranded conductor which includes wires concentrically combined around one or several wires; a bunch stranded conductor including plural wires bundled together and combined in the same direction; or a rope lay conductor including plural bunch stranded conductors concentrically combined.

The diameter of the conductor 1 and the diameter of each wire constituting the conductor 1 are not particularly limited. The material of the conductor 1 is not particularly limited and can be made of a publicly-known electric conductive metallic material such as copper, copper alloys, aluminum, and aluminum alloys, for example. The surface of the conductor 1 may be plated. To be specific, the surface of the conductor 1 may be tin-plated, silver-plated, or nickel-plated, for example.

The material and thickness of the insulator layer 2 covering the outer circumference of the conductor 1 are not particularly limited as long as the insulator layer 2 ensures electrical insulation from the conductor 1. Examples of the resin material constituting the insulator layer 2 are vinyl chloride, heat-resistant vinyl chloride, cross-linked vinyl chloride, polyethylene, cross-linked polyethylene, polyethylene foam, cross-linked polyethylene foam, polyethylene chloride, polypropylene, polyamide (nylon), polyvinylidene fluoride, ethylene-tetrafluoroethylene copolymer, tetrafluoroethylene-hexafluoropropylene copolymer, tetrafluoroethylene, perfluoroalkoxy alkane, natural rubber, chloroprene rubber, butyl rubber, ethylene propylene rubber, chlorosulfonated polyethylene rubber, and silicone rubber. The insulator layer 2 may be composed of either one or combination of two or more of the aforementioned substances.

The highly-flexible electric wire 10 of the embodiment includes a lubricant 3 between the conductor 1 and insulator layer 2. The lubricant 3 preferably contains at least one selected from the group consisting of polyethylene glycol, polypropylene glycol, and fluorine lubricants. Polyethylene glycol, polypropylene glycol, and fluorine lubricants are liquid at temperatures at which the highly-flexible electric wire is normally used. Accordingly, providing the liquid layer of the lubricant 3 between the conductor 1 and insulator layer 2 enables the conductor 1 and insulator layer 2 to slide smoothly on each other and reduces the frictional force therebetween. Accordingly, the conductor 1 can move in directions which reduce the strain when the electric wire is bent, so that the flexibility of the electric wire is increased.

The lubricant 3 preferably contains at least one selected from the group consisting of polyethylene glycol, polypropylene glycol, and fluorine lubricants as a main component. To be specific, the content of at least one selected from the group consisting of nolyethvlene glycol, polypropylene glycol, and fluorine lubricants in the lubricant 3 is not less than 50% by weight in total and is more preferably not less than 80% by weight. The lubricant 3 may consist of at least one selected from the group consisting of polyethylene glycol, polypropylene glycol, and fluorine lubricants.

The lubricant 3 is liquid, as described above. Accordingly, when the conductor 1 is composed of a stranded conductor, the liquid lubricant 3 penetrates not only between the conductor 1 and insulator layer 2 but also between wires constituting the stranded conductor as illustrated in FIG. 1. This also enables the wires to slide smoothly on each other and reduces the frictional force therebetween. When there is no lubricant interposed between the wires, the wires come into contact and rub against each other with strong contact pressure. This can cause wear and breakage of the electric wire. However, providing liquid lubricant between adjacent wires like the embodiment can prevent wear and breakage even when the electric wire is bent and the wires come into contact with strong contact pressure.

In the embodiment, the lubricant 3 contains at least one selected from the group consisting of polyethylene glycol, polypropylene glycol, and fluorine lubricants as described above, so that the frictional force between the conductor 1 and insulator layer 2 can be reduced. When the highly-flexible electric wire is used in vehicles in particular, the lubricant 3 is preferably in the liquid state in a temperature range from −40 to 80° C. because vehicles are normally used in. an environmental temperature of −40 to 80° C. Accordingly, it is preferable that polyethylene glycol, polypropylene glycol, and fluorine lubricants used in the lubricant 3 are in liquid state in the aforementioned temperature range. The polyethylene glycol used in the lubricant 3 preferably have a number average molecular weight of 200 to 300. The polypropylene glycol used in the lubricant 3 preferably have a number average molecular weight of not, more than 800. The fluorine lubricants used in the lubricant 3 are preferably lubricants containing polytetrafluoroethylene. The fluorine lubricants used in the lubricant 3 are also preferably lubricants containing fluorine inert liquid and fluorine lubricating oil in addition to polytetrafluoroethylene.

If the lubricant between the conductor and insulator layer is paraffin oil or grease, the lubricity between the wires constituting the conductor could be degraded at low temperatures because paraffin oil and grease are solid or semi-solid in a low-temperature range. Accordingly, such an electric wire is likely to have insufficient flexibility in the temperature range from −40 to 80° C. Moreover, when the lubricant is silicone oil, the existence of low molecular weight siloxane could cause conduction failure. As the thus-configured electric wire is used, low molecular weight siloxane is oxidatively decomposed to produce silicon dioxide, causing conduction failure.

On the other hand, polyethylene glycol, polypropylene glycol, and fluorine lubricants remain in liquid state in the normal range of operating temperatures of the electric wire and are less likely to cause conduction failure due to production of non-conductive substances. Accordingly, polyethylene glycol, polypropylene glycol, and fluorine lubricants are especially suitable as the constituent of the lubricant of the embodiment.

The amount of the lubricant 3 applied is not particularly limited as long as the lubricant 3 can adhere to the circumference of the conductor 1 and enable the conductor 1 and insulator layer 2 to slide smoothly on each other. When the conductor 1 is composed of a stranded conductor, the amount of the lubricant 3 applied is not particularly limited as long as the lubricant 3 enables the conductor 1 and insulator layer 2 to slide smoothly on each other and enables the wires constituting the conductor 1 to slide smoothly on each other.

As illustrated in FIG. 1, the insulator layer 2 of the embodiment may be formed by full extrusion to cause the resin constituting the insulator layer into gaps in the conductor. Alternatively, the insulator layer 2 may be formed by tubing so that the conductor 1 is arranged within the insulator layer 2 which is substantially tubular, like a highly-flexible electric wire illustrated in FIG. 2. In both cases, when the insulator layer 2 is formed by full extrusion or tubing, use of the liquid lubricant 3 enables the conductor 1 and insulator layer 2 to slide smoothly on each other.

The insulator layer 2 of the embodiment may further contain various additives in addition to the aforementioned material. The additives include antioxidants, metal deactivators, anti-aging agents, lubricating agents, fillers, stiffeners, ultraviolet absorbers, stabilizers, plasticizers, pigments, dyes, colorants, antistatic agents, and foaming agents.

The method of producing the highly-flexible electric wire 10 according to the embodiment is not particularly limited, and the highly-flexible electric wire 10 can be produced by extrusion molding, for example. To be specific, the resin material constituting the insulator layer 2 and necessary additives are put into an extruder set to a temperature at which the resin material melts sufficiently. The resin material and the like are molten and kneaded by a screw, and a certain amount thereof is supplied to a cross head through a breaker plate. The molten resin material and the like are flown onto the circumference of a nipple by a distributer and are extruded with a dice so as to cover the outer circumference of the conductor. The highly-flexible electric wire 10 in which the outer circumference of the conductor 1 is coated with the insulator layer 2.

The lubricant 3 is interposed between the conductor 1 and insulator layer 2 by applying the lubricant 3 to the conductor 1 before the conductor 1 is inserted into the nipple and dice. The method of applying the lubricant 3 to the conductor not particularly limited. The lubricant 3 may be applied by spraying before the conductor 1 is inserted into the dice, for example. Alternatively, the lubricant 3 may be applied by bringing the conductor 1 through a coating bath holding the lubricant. The lubricant applied to the conductor 1 may be dried if necessary. The surplus of the lubricant applied to the conductor 1 may be removed by flowing air.

In the process of extrusion molding, the temperature of molten resin which is extruded from the dice and adheres to the conductor 1 to form the insulator layer 2 is 150° C. or higher. The lubricant applied to the conductor 1 volatizes because of the high-temperature molten resin, and the amount of lubricant applied could be insufficient. It is therefore preferable that the lubricant has a boiling point of 150° C. or higher. When the lubricant has a boiling point of 150° C. or higher, the vaporization in the process of extrusion molding can be prevented, so that a sufficient amount of lubricant can be applied. However, the boiling point of the lubricant may be lower than 150° C. if the vaporization of the lubricant in the process of extrusion molding can be prevented or if a sufficient amount of lubricant remains on the circumference of the conductor 1 even though some of the lubricant vaporizes.

As described above, the highly-flexible electric wire of the embodiment includes a lubricant between the conductor and insulator layer, and the lubricant contains at least one selected from the group consisting of polyethylene glycol, polypropylene glycol, and fluorine lubricants. Accordingly, the lubricant remains in liquid state and therefore enables the conductor and insulator layer to slide smoothly on each other, so that the flexibility of the electric wire is increased. Furthermore, when the conductor is composed of a stranded conductor, the lubricant is interposed between the wires, therefore preventing wear and. breakage of the conductor.

### EXAMPLES

Hereinafter, the present invention is described in more detail by using examples and comparative examples. The present invention is not limited to the examples.

### Preparation of Samples

As samples of the examples, electric wires including the fluorine lubricant applied to conductors are prepared. As samples of the comparative examples, electric wires not including the fluorine lubricant applied to conductors are prepared.

Specifically, in each example, by bringing each conductor through a coating bath holding a fluorine lubricant, the fluorine lubricant is applied to the circumference of the conductor. The conductor with the lubricant applied thereto is then dried, and the insulator layer is extruded onto the circumference of the conductor, thus preparing an electric wire of the example. In the comparative examples, each electric wire is prepared by extruding the insulator layer onto the circumference of the conductor without applying a fluorine lubricant to the conductor.

In the examples and comparative examples, each electric wire is ISO-compliant HFSS 2f (product name) which is prepared by using annealed copper as the material of the conductor and using polypropylene as the material of the insulator layer. To be specific, in the electric wires of the examples and comparative examples, the conductor is composed of 37 wires; each wire has a diameter of 0.26 mm; the conductor has an outer diameter of 1.85 mm; and the insulator layer has a thickness of 0.35 mm. The fluorine lubricant is a lubricant containing 75 to 85% by mass of fluorine inert liquid, 15 to 20% by mass of fluorine. lubricating oil, and 1 to 5% by mass of polytetrafluoroethylene.

### Evaluation

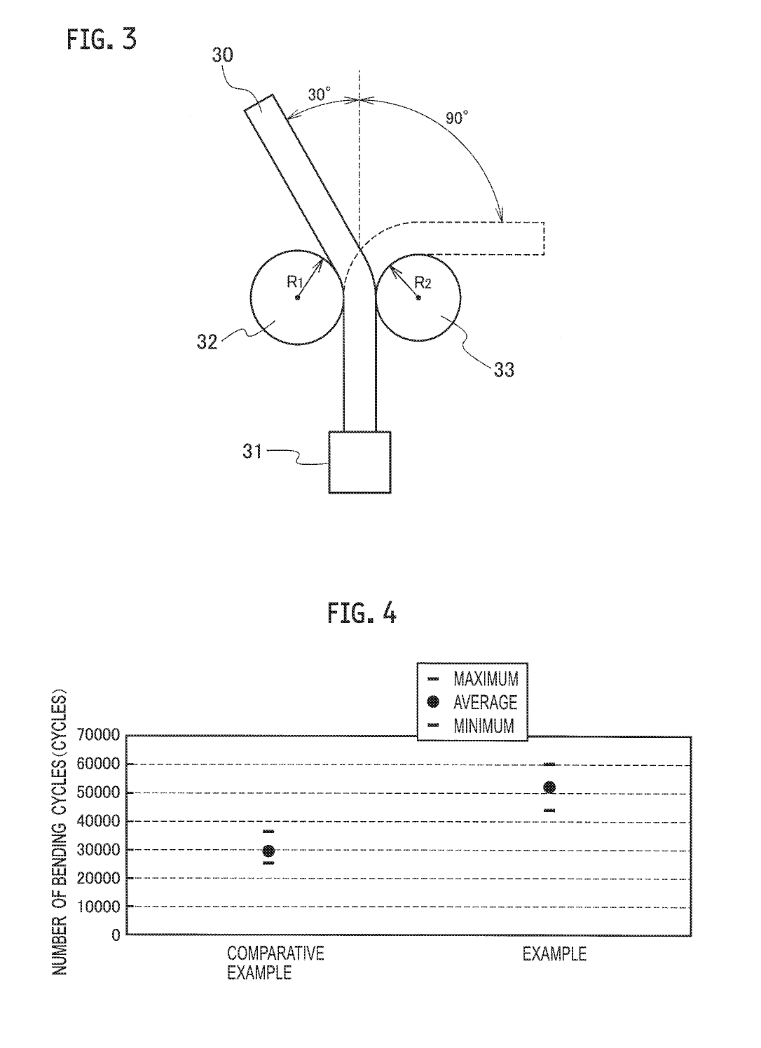

The electric wires of the examples and comparative examples obtained as described above are subjected to a bending durability test which is almost compliant with the International Electrotechnical Commission (IEC) 60227-2 by using an apparatus illustrated in FIG. 3. The testing method prescribed in IEC60227-2 is partially modified as follows.

In the bending durability test, as illustrated in FIG. 3, a weight 31 is attached to the lower end of each of electric wires 30 of the examples and comparative examples as a load on the electric wire 30. Moreover, the central part of the electric wire 30 is sandwiched by first and second jigs 32 and 33 which have curves to form a bend in the electric wire 30. Herein, the curvature radius R₁ of the first jig 32 shown on the left is 20 mm, and the curvature radius R₂ of the second jig 33 shown on the right is 12.5 mm.

In each bending cycle of the bending durability test, the electric wire 30 is bent in such a manner that the part of the electric wire 30 above the first and second jigs 32 and 33 is sequentially positioned at 30 degrees to the left of the original position of the electric wire 30, then 90 degrees to the right, and back to 30 degrees to the left. The electric wire 30 is repeatedly subjected to the aforementioned cycle, and the number of bending cycles until the conductor is broken is examined. The bending durability test is performed on six samples, the results of which are illustrated in FIG. 4.

As illustrated in FIG. 4, as for the electric wires of the examples, the average number of bending cycles before breakage is 51929, and the maximum and minimum values thereof are 60189 and 43938, respectively. On the other hand, as for the electric wires of the comparative examples, the average number of bending cycles before breakage is 30444, and the maximum and minimum values thereof are 37107 and 25746, respectively. This reveals that use of the liquid lubricant between the conductor and insulator layer improves the lubricity between the conductor and insulator layer and between the wires and reduces the frictional force, so that the bending durability of the electric wire is considerably increased.

The highly-flexible electric wire of the present invention includes liquid lubricant between the conductor and insulator layer. Accordingly, the conductor and insulator layer thereof slide smoothly on each other, and the flexibility of the electric wire is increased.

Hereinabove, the present invention is described based on the embodiments. However, the present invention is not limited to the embodiments and can be variously modified without departing from the scope of the present invention.

What is claimed is:

1. A highly-flexible electric wire, comprising:
a conductor; and
an insulator layer covering the conductor,
wherein a liquid lubricant is interposed between the conductor and the insulator layer and contains at least one selected from the group consisting of polyethylene glycol, polypropylene glycol, and fluorine lubricants.

2. The highly-flexible electric wire according to claim 1, wherein the conductor is a stranded. conductor composed of a bundle of plural wires, and
the lubricant is interposed between the conductor and the insulator layer and between the wires adjacent to each other.

3. The highly-flexible electric wire according to claim 1, wherein the lubricant is in liquid state in a temperature range from −40 to 80° C. and has a boiling point of 150° C. or higher.

4. The highly-flexible electric wire according to claim 2, wherein the lubricant is in liquid state in a temperature range from −40 to 80° C. and has a boiling point of 150° C. or higher.
